(19) United States
(12) Patent Application Publication
(10) Pub. No.: US 2002/0141013 A1
(43) Pub. Date: Oct. 3, 2002

(54) Integrated optical networking transport/switching architecture

(76) Inventors: Naimish Patel, North Andover, MA (US); Farzana I. Khatri, Andover, MA (US); Anthony Chi-Kong Kam, Cambridge, MA (US); Paolo Narvaez, Mountain View, CA (US); Eric A. Swanson, Acton, MA (US); Richard A. Barry, Brookline, MA (US)

Correspondence Address: LAHIVE & COCKFIELD, 28 STATE STREET, BOSTON, MA, 02109, US

(21) Appl. No.: 10/042,070

(22) Filed: Oct. 19, 2001

Related U.S. Application Data
(60) Provisional application No. 60/280,686, filed on Mar. 30, 2001.

(51) Int. Cl. H04J 14/02

(52) U.S. Cl. 359/124; 359/127

(57) ABSTRACT

An optical node for providing transport and switch functions on an incoming optical signal with a plurality wavelengths each with a plurality of signal components in a WDM optical network. The optical node includes a first module for taking, extracting and processing the plurality of wavelengths, a second module with a plurality of input ports and a plurality of output ports which further extract the signal components from the plurality of wavelengths, and a third module for taking and processing the signal components and sending them to the plurality of output ports in the second module. A method of processing the wavelengths in one of the nodes first inputs the optical signal that extracts wavelengths from the optical signal, and further extracts signal components from the wavelengths, to allocate signal components onto the input ports. Finally the method switches the signal components from the input ports to the output ports of the optical node.

### CROSS REFERENCE TO RELATED APPLICATIONS

This application claims priority under 35 U.S.C. §119(e) to provisional patent application No. 60/280,686, filed Mar. 30, 2001, the disclosure of which is hereby incorporated by reference herein.

### FIELD OF THE INVENTION

The present invention relates generally to optical communication systems and more particularly to an integrated transport/switch architecture.

### BACKGROUND OF THE INVENTION

Driven by data traffic characterized by rapid growth and unpredictable demand which is unlike voice traffic that is generally characterized by slow growth and stable demand. As such, carriers need to move to a just-in-time investment and service delivery model, to introduce and expand services when and where needed in response to demand so to manage the frequently unpredictable demand of data traffic.

Intelligent optical networking, which is a flexible, highly scalable optical network architecture for the delivery of public network services, provides an innovative and practical solution to network scaling and high-speed service delivery issues. Intelligent Optical Networking brings intelligence and scalability to the optical domain by combining the functionality of SONET/SDH, the capacity creation of DWDM and innovative networking software into a new class of optical transport, switching and management products. These products collectively provide the capabilities to transform the optical layer of the network from a basic transmission medium into an intelligent optical network architecture that will support the delivery of services directly from the optical layer.

The intelligent optical network has traditionally been hierarchically divided into a transport platform and a switching platform. A transport platform is responsible for providing point-to-point physical connections. These physical connections are also referred to as trunks. The switching platform is then responsible for connecting these trunks in order to provide an end-to-end logical topology. A physical connection provided by a transport platform is generally fixed. The path of the connection is configured manually, and cannot be rerouted without manual intervention. On the other hand, a switching platform can setup new connections automatically by using existing trunks. Connections can be established and rerouted quickly, without requiring human intervention. Most of the commercially available optical switches are based on CLOS architecture, which are 3-stage unidirectional switching networks, which are well known in the art. A Time-Space-Time fabric utilizing the above CLOS architecture has the first and third stages implemented as time slot switches and the middle stages implemented as pure space switches.

A combined switching/transport system can be constructed by using transport and switching platforms, such as a model SN 16000 switch and a model SN 10000 transport product both from Sycamore Networks in Chelmsford, MA. Such an approach is modular and maintains the differentiation between switching and transport network layers. The switch platform can be replaced by another switching platform without affecting any of the transport connections. Likewise, individual transport connections can be replaced by another type of connection without affecting the trunk seen by the optical switches.

The main drawback of this current approach is that it is expensive. Because the transport platform is intended to operate with any switching platform and vice-versa, a full short-reach optical interface must be used to connect the two platforms. Apart from the expensive optical transceivers required for interconnection, many common functions are duplicated. For example, SONET overhead monitoring is performed in both the transport and switch products, causing redundancy of functionality.

It would, therefore, be desirable to provide optical networks with an architecture to integrate multiple functions, such as transport and switching.

### SUMMARY OF THE INVENTION

The present invention provides a system and a method of integrating transport and switch functions into one platform so to provide cost-efficient and function reduction systems.

In one aspect of the invention, an optical node for providing transport and switch functions on an incoming optical signal with a plurality wavelengths. Each wavelength includes a plurality of signal components in a wavelength division multiplexing (WDM) optical network. The optical node includes a first module for taking, extracting and and a plurality of output ports which further extract the signal components from the plurality of wavelengths, and a third module for taking and processing the signal components extracted by the second module and sending them to the plurality of output ports in the second module.

In another aspect of the invention, a method of processing the optical wavelengths in a node of a WDM optical network is practiced. The optical network includes a plurality of nodes with a plurality of input ports and a plurality of output ports are connected by an optical transmission medium carrying an optical signal having a plurality of wavelengths. Each wavelength includes a plurality of signal components.

In still another aspect of the invention, a plurality of port interface cards in an optical switch node contains a plurality of dense wavelength division multiplexing (DWDM) lasers for interconnecting with a plurality of wavelength signals. The port interface cards are also connected with a switch chassis in the optical switch node. The interconnection between the port interface cards and the switch chassis is via optical transceivers such as Vertical Cavity Surface Emitting Laser (VCSEL).

### BRIEF DESCRIPTION OF THE DRAWINGS

The invention will be more fully understood from the following detailed description taken in conjunction with the accompanying drawings, in which:

FIG. 1 is a conventionally combined optical transport/switch system.

FIG. 2A is the function block diagram of transport FIU.

FIG. 2B is the function block diagram of transport TIU.

FIG. 3 is a 3-stage CLOS network.

FIG. 4A shows a port chassis function diagram of a switch node.

FIG. 4B shows a switch chassis function diagram of a switch node.

FIG. 5A shows layout of DWDM PIC card in accordance with the present invention.

FIG. 5B shows layout of DWDM interface portion of the DWDM PIC card.

FIG. 6 is an illustration of an integrated optical transport/switch system in accordance with the present invention.

FIG. 7 is another illustration of an integrated optical transport/switch system in accordance with the present invention.

### DETAILED DESCRIPTION

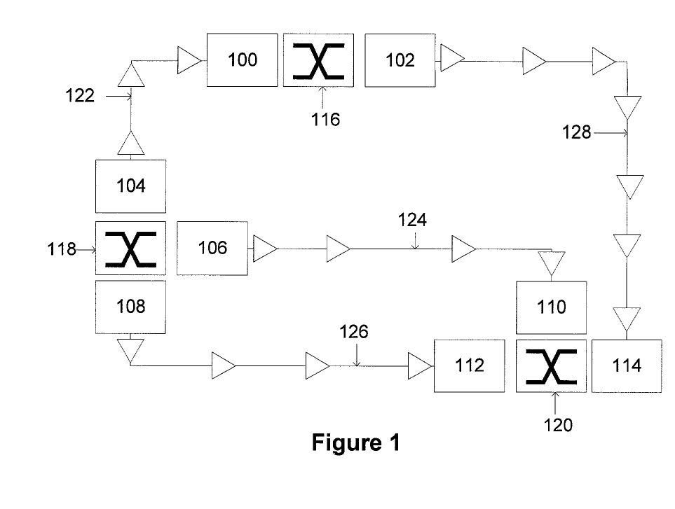

FIG. 1 shows a conventionally combined switching/transport system which can be constructed by using commercially available transport and switching platforms, such as a model SN 16000 optical switch platform and a model SN 10000 transport platform from Sycamore Networks, Chelmsford, Mass. A plurality of transport nodes 100, 102, 104, 106, 108, 110, 112, 114 are interconnected via a plurality of optical switches 116, 118, 120. The manual connections established over the transport network can be used as trunks 122, 124, 126, 128 in a switching network. Such an approach is modular and maintains the differentiation between switching and transport network layers. The optical switch platform can be replaced by another switching platform without affecting any of the transport connections. Likewise, an individual transport node can be replaced by another type of transport node without affecting the trunk seen by the optical switches.

The main drawback of this current approach is that it is expensive. Because the transport platform is intended to operate with any switching platform and vice-versa, a full short-reach optical interface may be used to connect the two platforms. Apart from the expensive optical transceivers required for interconnection, many common functions are duplicated. For example, SONET overhead monitoring is performed in both the transport node and optical switch. In a combined node as in FIG. 1, this functionality is clearly redundant.

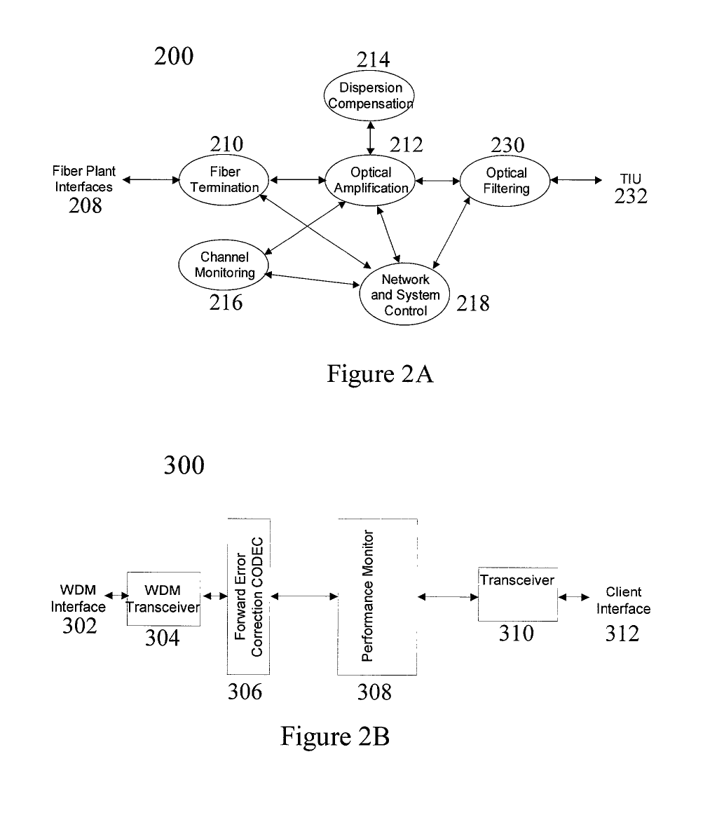

Commercially available transport platforms, such as model SN 10000 platform from Sycamore Network, Chelmsford, Mass. provides a high-capacity transport system. Its functionality can be divided into a fiber interface unit (FIU) and a transponder interface unit (TIU). As shown in FIG. 2A, the FIU 200 provides all the optical functionality, such as optical amplification and wavelength multiplexing. It takes a WDM optical signal via the fiber plant interface 208, the fiber plant is terminated in the fiber termination subsystem 210 which performs an add/drop of the Optical Supervisory Channel (OSC), and optical tapping of egress and ingress signals for hand-off to the channel monitoring sub-system 216. The amplification sub-system 212 performs conventional EDFA-based optical amplification and has input/output to the dispersion compensation sub-system 214 and the optical filtering sub-system 230. All wavelength multiplexing and demultiplexing and fixed add/drop are accomplished within the optical filtering subsystem 230 and then feed into TIU 232. The network and system control sub-system 218 performs network-element level, and network wide management and control functions. As shown in FIG. 2B, the TIU 300 provides all the electronic functionality, such as electrical termination and SONET processing. The client signals via client interface 312 is taken and processed, the performance is monitored via performance monitor 308 and sent to the Forward Error Correction (FEC) 306, and eventually to the WDM transceiver 304 and feed to FIU via WDM interface 302.

A commercially available switching platform, such as model SN 16000 switching platform from Sycamore Network, Chelmsford, Mass. provides a high-capacity switching system. A three-stage CLOS based architecture, which is what most optical switch platforms are based upon, has functionality that can be divided into a port chassis, through its Port Interface Card (PIC) cards, which provides the interfaces to both external and internal ports, and a switch chassis which provides the CLOS switch center stage required to automatically connect any port interface to any other port interface.

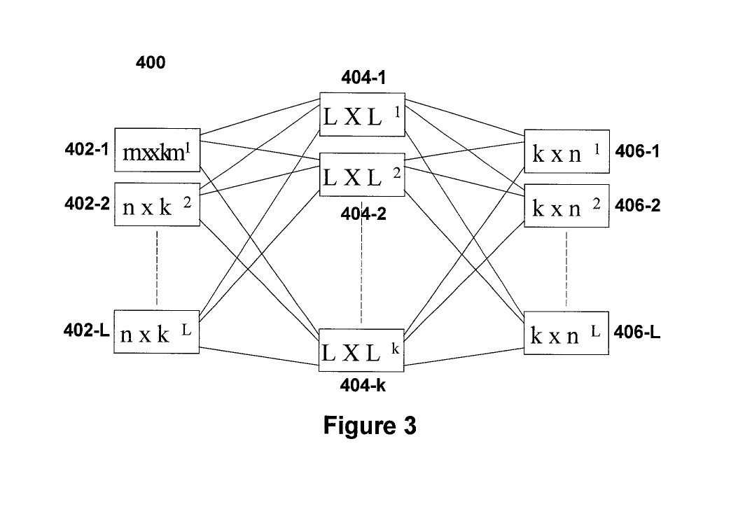

FIG. 3 shows a 3-stage CLOS network, which is well known in the art. As depicted in FIG. 3, a typical CLOS network 400 includes a source stage that includes a plurality of L source modules 402-1 to 402-L, wherein each source switching module is a (n×k) switch, which may be a crossbar switch. The k output ports of the L source modules are connected to the input ports of a midstage switching stage. The midstage switching stage includes k midstage switching modules 404-1 to 404-k each having L input ports, wherein each of the midstage switching modules is an L×L switch, which may be a crossbar switch. The L output ports of the midstage switching modules are connected to the input ports of a destination stage. The destination stage includes L destination modules, 406-1 to 406-L wherein each of the L destination modules is an k×n switch, which may be a crossbar switch. Thus, for every input port of the L source modules there is exactly one connection, i.e., one unit of edge capacity, between the input port and any midstage switching module. Similarly, there is exactly one connection, i.e., one unit of edge capacity, between each of the K midstage switching modules and each of the L destination modules. One or more input signal each having one or more component signals associated with a source and destination identifier, each component signal having further associated with a bandwidth requirement, can be applied or allocated to one or more input ports on one or more of the source switching modules. The signals are then routed over the various midstage switching modules and will be eventually routed to their respective output ports on the third stage.

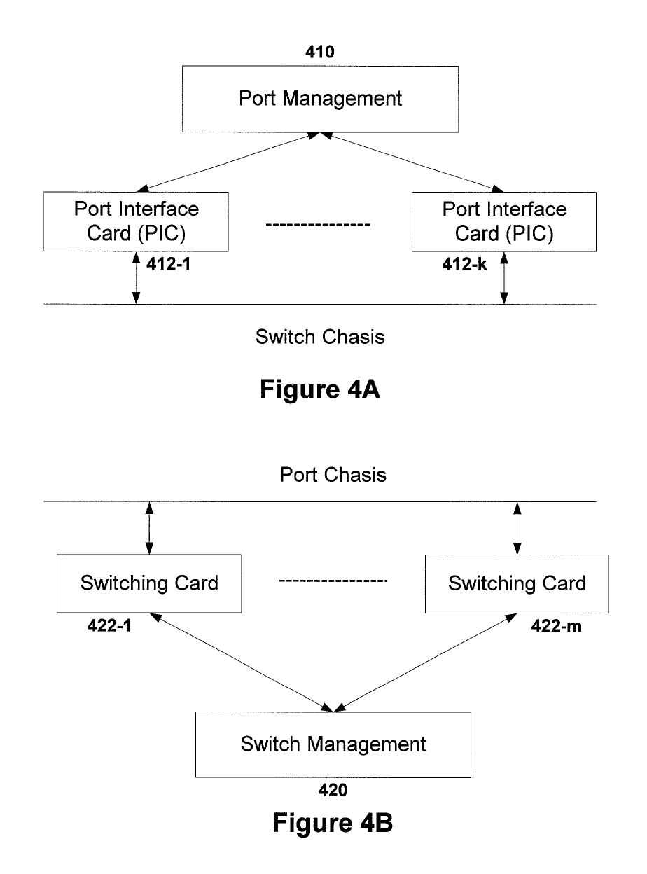

The port interface card (PIC) cards can come in a variety of forms. The basic function will be to bridge and select data onto and from the optical interconnect and switch fabrics. In addition, it can also implement the first and third stage switching elements of the CLOS network depending on the specific implementations. As such, each PIC can have a plurality of VCSEL transmit elements and a plurality of receive elements. The optical outputs and inputs of these elements are connected through a backplane connector to the optical inter-chassis cable. The remaining functionality on the port interface card depends on the type of data interfaces, such as multiple OC-48 SONET streams. FIG. 4A shows a port chassis function diagram of one possible implementation. The port management 410 is responsible for monitoring the status of each PIC and distributing timing references amongst PICs. 412-1 and 412-k are a plurality of PICs which are interconnected with switch chassis.

FIG. 4B shows the switch chassis function diagram, as one possible implementation for illustration purposes. A plurality of the switching cards 422-1, 422-m contain the switching elements of the CLOS network are managed by switch management block 420 which is responsible for monitoring the status of all switch cards and configuring the state of each. The switching cards are interconnected with PICs in port chassis.

The interconnection between port chassis and switch chassis can be in the form of either an electrical interconnect or an optical interconnect, such as via VCSELs. The switching cards can be space switches in a time-space-time CLOS architecture with or without grooming capability.

Referring back to FIG. 1, for networks that use both transport and switching platforms, a significant cost reduction can be achieved by further combining the two platforms and eliminating some of the redundant functionality. As illustrated in FIG. 2 and FIG. 4 the function blocks of transport and switch platforms, allow functional redundancy to be decreased by moving some of the DWDM functionality from the TIU in transport node to the port chassis in a switch. The PIC on the port chassis is given DWDM optics that can connect directly to the transport FIU. This eliminates the need for the TIU chassis.

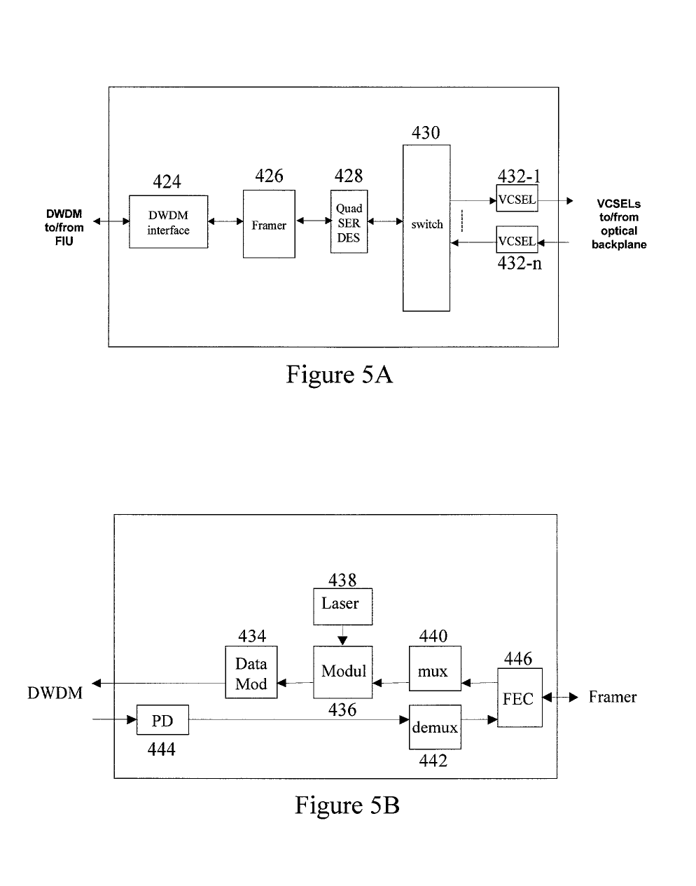

FIG. 5A shows the layout of DWDM PIC card in accordance with the present invention. For illustration purposes, the implementation in FIG. 5A includes a DWDM customer input/output using optical transponders, which further comprises a DWDM interface 424, a framer 426 to translate a client signal into a SONET signal, a module 428 providing clock, data recovery, pointer processing, performance monitoring, and section and line overhead byte access. A module providing function of the first and third stage of the three-stage CLOS network such as a switch 430 which can further include grooming capability, for example, optical transceivers such, as VCSELs 432-1 to 432-n interconnect to optical backplane.

FIG. 5B shows the layout of the DWDM interface portion of the DWDM PIC card in FIG. 5A. For the signal flow from DWDM to framer, a photodetector (PD) 444 is used to detect the DWDM signal, a demux 442 is used to extract signal components from the DWDM signal, and the FEC 446 is used to mitigate the system effects of various signal channel impairments, finally the signal components are feed into the framer. For the signal flow from framer to DWDM, after the signal components are processed by FEC 449, they will be muxed together by multiplexer 440 and then modulated via modulator 436 by laser 438, and is further modulated by data modulator 434. Finally the optical signal is sent to an optical fiber as a DWDM signal. Optionally, after data modulator 434 but before the signal is sent to optical fiber, the signal can be sent through a variable optical attenuator (VOA) for controlling the optical power propagating.

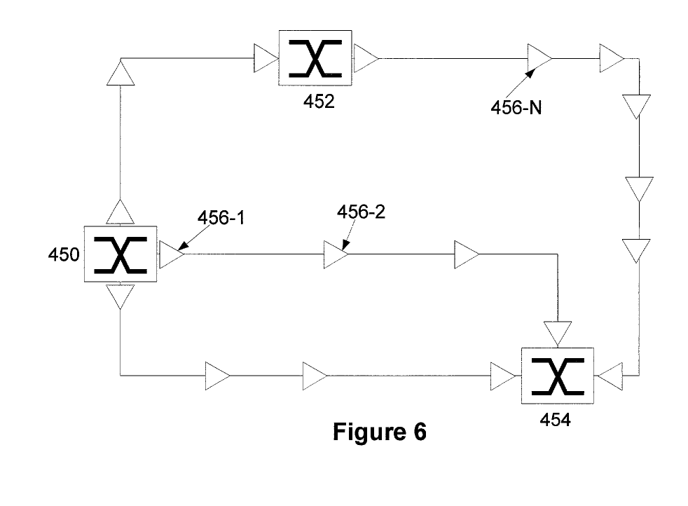

In FIG. 6, an integrated transport/switch network element is constructed by combining a transport FIU with a switch (port chassis and switch chassis). The triangles 456-1, 456-2, 456-N represent amplifiers/FIU's, in the transport platform. However, at the switching nodes 450, 452, 454, the transport and switch equipments have been combined. The transport TIU and the switch PIC are merged together into a signal apparatus The PIC cards in the switch port chassis are WDM-enhanced so that they can launch the signal directly into the FIU, without having to be regenerated by a transport TIU module. Such a network element may also have additional transport TIUs connected to the FIUs. These TIUs can provide complementary low-cost transport without switching.

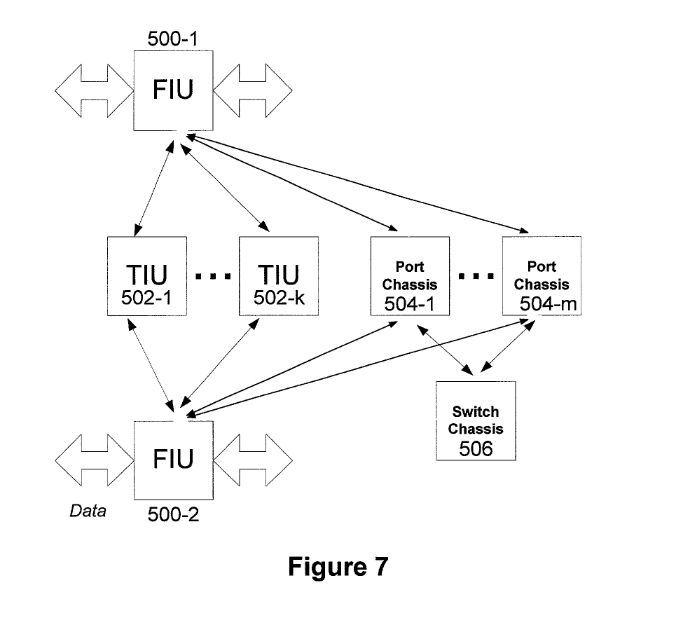

FIG. 7 shows an another illustrated configuration. Wavelengths that are not switched continue to be handled by the transport platform only via TIUs 502-1, 502-k, and the FIUs 500-1 and 500-2 will still be able to control an entire transport node. In addition, wavelengths that are switched are mostly controlled by the switch node via the port chassis 504-1, 504-m and switch chassis 506. In these cases, the FIU controls only the optical aspect of the connection. All aspects that fall into the electronic domain (switching, performance monitoring, SONET transparency, etc.) are handled by the switch node directly.

It will be apparent to those of ordinary skill in the art that other embodiments incorporating the disclosed concepts may be used. Accordingly, it is submitted that the invention should not be limited by the described embodiments but rather should encompass the spirit and full scope of the appended claims.

What is claimed is:

1. An optical node for processing an incoming optical signal with a plurality wavelengths with each of said plurality of wavelengths having a plurality of signal components in a wavelength division multiplexing (WDM) optical network, comprising:
a first module for receiving, extracting and processing said plurality of wavelengths;
a second module with a plurality of input ports and a plurality of output ports for extracting each of said plurality of signal components from said plurality of wavelengths processed by said first module; and
a third module for routing said plurality of signal components from said input ports to said plurality of output ports in said second module.

2. The optical node of claim 1, wherein the second module and the third module are interconnected via optical transceivers.

3. The optical node of claim 1, wherein the first module and the second module are interconnected via optical transponders.

4. The optical node of claim 1, wherein said processing by said first module provides fiber and wavelength layer functions.

5. The optical node of claim 1, wherein said extracting by said second module provides wavelength to circuit adaptation function.

6. The optical node of claim 1, wherein said extracting by said second module further provides one or more circuit layer functions.

7. The optical node of claim 1, wherein said processing by said third module provides a space switch function.

8. The optical node of claim 2, wherein the optical transceivers comprise a vertical cavity surface emitting laserdiode (VCSEL).

9. The optical node of claim 4, wherein the fiber and wavelength layer functions provided by the first module comprise wavelength multiplexing and wavelength demultiplexing functions.

10. The optical node of claim 4, wherein the fiber wavelength layer functions provided by the first module further comprise wavelength add and wavelength drop functions.

11. The optical node of claim 4, wherein the fiber and wavelength layer function of the first module further comprise a wavelength power balancing function.

12. The optical node of claim 4, wherein the fiber and wavelength layer function of the first module further includes a wavelength dispersion compensation function.

13. The optical node of claim 4, wherein the fiber and wavelength layer function of the first module further comprises a wavelength amplification function.

14. The optical node of claim 4, wherein the fiber and wavelength layer function of the first module further comprises a wavelength protection function.

15. The optical node of claim 5, wherein the wavelength to circuit adaptation function comprises wavelength division multiplexing (WDM) transponding function.

16. The optical node of claim 6, wherein the one or more circuit layer functions comprises a signal regeneration function.

17. The optical node of claim 6 wherein the one or more circuit layer functions further comprises an electrical add and an electrical drop function.

18. The optical node of claim 6, wherein the one or more circuit layer functions further comprises a per circuit performance monitoring function.

19. The optical node of claim 6, wherein the one or more circuit layer functions further comprises a circuit protection function.

20. An optical node for processing an incoming optical signal with a plurality wavelengths with each of said plurality of wavelengths having a plurality of signal components in a wavelength division multiplexing (WDM) optical network, comprising:
a first module for receiving, extracting and processing said plurality of wavelengths;
a second module for extracting each of said plurality of signal components from said plurality of wavelengths processed by said first module; and
a third module with a plurality of input ports and a plurality of output ports for routing said plurality of signal components from said input ports to said plurality of output ports.

21. The optical node of claim 20, wherein said processing by said first module provides fiber and wavelength layer functions.

22. The optical node of claim 20, wherein said extracting by said second module provides wavelength to circuit adaptation function.

23. The optical node of claim 20, wherein said extracting by said second module further provides one or more circuit layer functions.

24. The optical node of claim 21, wherein the fiber and wavelength layer functions provided by the first module comprise wavelength multiplexing and wavelength demultiplexing functions.

25. The optical node of claim 21, wherein the fiber wavelength layer functions provided by the first module further comprise wavelength add and wavelength drop functions.

26. The optical node of claim 21, wherein the fiber and wavelength layer function of the first module further comprise a wavelength power balancing function.

27. The optical node of claim 21, wherein the fiber and wavelength layer function of the first module further includes a wavelength dispersion compensation function.

28. The optical node of claim 21, wherein the fiber and wavelength layer function of the first module further comprises a wavelength amplification function.

29. The optical node of claim 21, wherein the fiber and wavelength layer function of the first module further comprises a wavelength protection function.

30. The optical node of claim 22, wherein the wavelength to circuit adaptation function comprises wavelength division multiplexing (WDM) transponding function.

31. The optical node of claim 23, wherein the one or more circuit layer functions comprises a signal regeneration function.

32. The optical node of claim 23, wherein the one or more circuit layer functions further comprises an electrical add and an electrical drop function.

33. The optical node of claim 23, wherein the one or more circuit layer functions further comprises a per circuit performance monitoring function.

34. The optical node of claim 23, wherein the one or more circuit layer functions further comprises a circuit protection function.

35. In an optical node with a plurality of input ports and a plurality of output ports a method of processing an optical signal with a plurality of wavelengths with each of the plurality of wavelengths having a plurality of signal components, the method comprising the steps of:
inputting said optical signal;
extracting said plurality wavelengths from said optical signal;
extracting said plurality of signal components from each of said plurality of wavelengths;
allocating said plurality of signal components onto said input ports; and
switching said plurality of signal components from said input ports to said output ports;

36. The method according to claim 35, wherein said step of extracting said plurality of wavelengths from said optical signal further comprises the step of amplifying said extracted plurality of wavelengths.

37. The method according to claim 35, wherein said step of extracting said plurality of wavelengths from said optical signal further comprises the step of performing dispersion slope compensation on each of said plurality of extracted wavelengths.

38. The method according to claim 35, wherein said step of extracting said plurality of wavelengths from said optical signal further comprises the step of performing polarization mode dispersion compensation on each of said plurality of extracted wavelengths.

39. The method according to claim 35, wherein said step of extracting said plurality of wavelengths from said optical signal further comprises the step of performing dispersion compensation on each of said plurality of extracted wavelengths.

40. The method according to claim 35, wherein said step of extracting said plurality of wavelengths from said optical signal further comprises the step of monitoring performance of each of said plurality of extracted wavelengths.

41. The method according to claim 35, wherein said step of extracting said plurality of wavelengths from said optical signal further comprises the step of protecting each of said plurality of extracted wavelengths.

42. The method according to claim 35, wherein said step of extracting said plurality of signal components from each of said plurality of wavelengths further comprises the step of performing signal regeneration on each of said plurality of extracted signal components.

43. The method according to claim 35, wherein said step of extracting said plurality of signal components from each of said plurality of wavelengths further comprises the step of monitoring performance of each of said plurality of extracted signal components.

44. The method according to claim 35, wherein said step of extracting said signal components from each of said wavelengths further comprises the step of protecting each of said plurality of extracted signal components.

45. An optical switch node, comprising:
a plurality of port interface circuit card assembles having mounted thereto, a plurality of dense wavelength division multiplexing (DWDM) lasers having a plurality of wavelengths for interconnecting said plurality of port interface circuit card assembles with a switch chassis; and
a plurality of optical transceivers to interconnect said plurality of port interface circuit card assembles with said switch chassis.

46. The optical switch node of claim 45, wherein the plurality of port interface circuit card assembles further comprises a dense wavelength division multiplexing (DWDM) interface for receiving and processing a plurality of optical channel signals.
